(19) United States
(12) Patent Application Publication
(10) Pub. No.: US 2025/0178906 A1
(43) Pub. Date: Jun. 5, 2025

(54) System and Method for Producing Carbon Nanotubes

(71) Applicant: SK Innovation Co., Ltd., Seoul (KR)

(72) Inventors: Young Kwang KIM, Daejeon (KR); Soo Bean KIM, Daejeon (KR); Hyun Suk CHUNG, Daejeon (KR); Yong Bin HAN, Daejeon (KR)

(21) Appl. No.: 18/966,194

(22) Filed: Dec. 3, 2024

(30) Foreign Application Priority Data
Dec. 4, 2023 (KR) 10-2023-0173267

(51) Int. Cl. C01B 32/16

(52) U.S. Cl. CPC C01B 32/16; C01B 2202/02

(57) ABSTRACT

A carbon nanotube production system according to the present disclosure includes a reactor configured to generate a carbon nanotube fluid in a first direction; a conveyor unit which is arranged spaced apart from the reactor in the first direction, and comprises a mesh belt configured to capture carbon nanotube structures from the carbon nanotube fluid while continuously traveling in a second direction perpendicular to the first direction; and a collection unit configured to collect carbon nanotube units from the carbon nanotube structures.

### CROSS-REFERENCE TO RELATED APPLICATION

This application claims priority to Korean Patent Application No. 10-2023-0173267 filed on Dec. 4, 2023, the disclosure of which is hereby incorporated by reference in its entirety.

### BACKGROUND

### Technical Field

The present disclosure relates to a system for producing carbon nanotubes and a method for producing carbon nanotubes.

### Technical Considerations

Carbon nanotubes (CNTs) are materials used in many fields due to their excellent chemical stability and mechanical properties, as well as high thermal conductivity.

Depending on synthesis conditions, the carbon nanotubes are classified into: single-walled carbon nanotubes having a structure made by rolling up one layer of graphite and connecting ends thereof; double-walled carbon nanotubes having a shape in which two layers of the single-walled carbon nanotubes are arranged about a concentric axis; and multi-walled carbon nanotubes composed of a plurality of single-walled carbon nanotubes in a multi-layer.

As a method for synthesizing the carbon nanotubes, there are method such as vapor deposition, electric discharge, laser ablation, high-pressure vapor deposition and the like. The synthesized carbon nanotubes have small particle sizes, such that final carbon nanotubes are generally obtained by aggregating their particles to improve handling properties.

In order to use as an additive, etc., the agglomerated carbon nanotubes need to be separated into individual carbon nanotube particles again. In this case, the process of separating the agglomerated carbon nanotubes again is complicated and takes a long period of time, thus a method for obtaining carbon nanotubes without the above-described process is required.

### SUMMARY

An object of the present disclosure is to provide a system for producing carbon nanotubes having improved process reliability and production efficiency.

Another object of the present disclosure is to provide a method for producing carbon nanotubes with improved process reliability and production efficiency.

One or more of the above objects may be achieved by one or more of the embodiments disclosed herein.

In some non-limiting embodiments or aspects of the present disclosure, provided is a system for producing carbon nanotubes comprising: a reactor configured to generate a carbon nanotube fluid in a first direction; a conveyor unit which is arranged spaced apart from the reactor in the first direction, and comprises a mesh belt configured to capture carbon nanotube structures from the carbon nanotube fluid while continuously traveling in a second direction perpendicular to the first direction; and a collection unit configured to collect carbon nanotube units from the carbon nanotube structures.

According to some embodiments, the carbon nanotube fluid may comprise a single-walled carbon nanotube aerosol.

According to some embodiments, the reactor may comprise a floating catalyst chemical vapor deposition (FC-CVD) reactor.

According to some embodiments, the system may further comprise a carbon source inlet part coupled to a front end of the reactor and an outlet part coupled to a rear end of the reactor to discharge the carbon nanotube fluid in the first direction.

According to some embodiments, a ratio of a moving speed (cm/s) of the mesh belt to a flow rate (cm³/s) at which the carbon nanotube fluid is discharged from the outlet part may be 0.16 cm⁻² to 0.65 cm⁻².

According to some embodiments, the system may further comprise a gas supply part configured to supply a carrier gas to the carbon source inlet part.

According to some embodiments, the conveyor unit may further comprise rollers configured to drive the mesh belt.

According to some embodiments, the collection unit may comprise a brush unit configured to collect the carbon nanotube structures with a predetermined size.

According to some embodiments, the mesh belt may comprise openings through which the carbon nanotube fluid passes by penetrating the mesh belt.

According to some embodiments, the system may further comprise a housing in which the mesh belt is accommodated, wherein the housing may comprise a vent portion through which the carbon nanotube fluid passing through the mesh belt is discharged.

According to some embodiments, the vent portion may be positioned in a linear flow direction of the carbon nanotube fluid in the first direction.

According to some embodiments, the reactor may comprise a plurality of reactors spaced apart from each other in the second direction.

According to some non-limiting embodiments or aspect of the present disclosure, provided is a method for producing carbon nanotubes, comprising: generating a carbon nanotube fluid in a first direction; supplying the carbon nanotube fluid onto a mesh belt continuously traveling in a second direction perpendicular to the first direction to form carbon nanotube structures; and collecting carbon nanotube units from the carbon nanotube structures.

According to some embodiments, the carbon nanotube fluid may be generated only in a single direction of the first direction.

According to some embodiments, the step of generating a carbon nanotube fluid may comprise generating a single-walled carbon nanotube aerosol through a floating catalyst chemical vapor deposition (FC-CVD) process.

The carbon nanotube production system according to some embodiments of the present disclosure may capture carbon nanotubes (e.g., SWCNTs) in the manufactured form as they are. Accordingly, non-agglomerated carbon nanotubes may be rapidly produced.

The carbon nanotube production system according to some embodiments of the present disclosure may comprise a mesh belt to efficiently collect the carbon nanotubes in an aerosol state. By directly passing a fluid comprising carbon nanotubes through the mesh belt, agglomeration of the carbon nanotubes may be prevented. Accordingly, carbon nanotubes having uniform physical properties may be produced.

According to the carbon nanotube production method of some embodiments of the present disclosure, it is possible to produce non-agglomerated carbon nanotubes in large quantities at a rapid speed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic view illustrating a carbon nanotube production system according to exemplary embodiments according to the principles of the present disclosure;

FIG. 2 is a schematic view illustrating a carbon nanotube production system according to a comparative example according to the principles of the present disclosure; and

FIG. 3 is a schematic view illustrating a carbon nanotube production system according to some exemplary embodiments according to the principles of the present disclosure.

### DETAILED DESCRIPTION

The present disclosure provides a carbon nanotube production system having improved production efficiency.

In addition, the present disclosure provides a carbon nanotube production method with improved process reliability and production efficiency.

Hereinafter, the present disclosure will be described in detail with reference to the accompanying drawings. However, the embodiments are merely illustrative and the present disclosure is not limited to the specific embodiments described by way of example.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

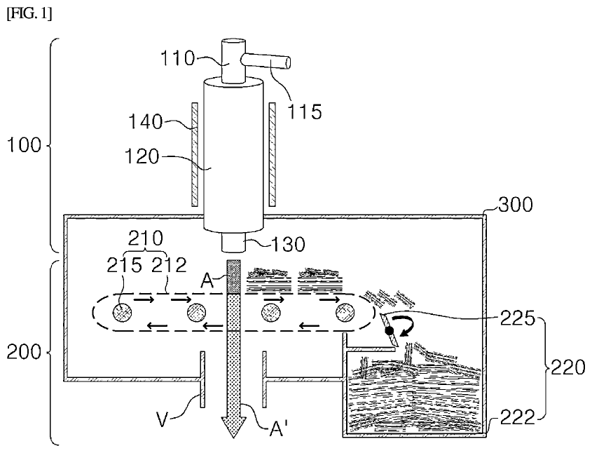

FIG. 1 is a schematic view illustrating a carbon nanotube production system according to non-limiting embodiments or aspects of the present disclosure. Hereinafter, the carbon nanotube production system and the production method will be described together with reference to FIG. 1.

Referring to FIG. 1, the carbon nanotube production system according to some embodiments may comprise a manufacturing section 100 and a capture section 200. In the manufacturing section 100, a carbon source may react at a high temperature to manufacture carbon nanotubes of the present disclosure. In the capture section 200, the carbon nanotubes manufactured in the manufacturing section 100 may be gathered and collected.

The manufacturing section 100 may comprise a carbon source inlet part 110, a reactor 120 and an outlet part 130. The carbon source inlet part 110 may be coupled to a front end of the reactor 120, and the outlet part 130 may be coupled to a rear end of the reactor 120.

The reactor 120 may comprise a floating catalyst chemical vapor deposition (FC-CVD) reactor, and carbon nanotubes may be manufactured in the manufacturing section 100 by a floating catalyst chemical vapor deposition (FC-CVD). The floating catalyst chemical vapor deposition method is a method capable of synthesizing carbon nanotubes by continuously supplying a catalyst and a carbon source as a raw material while spraying them. Accordingly, unlike batch-wise synthesis, it is possible to continuously produce the carbon nanotubes.

The carbon source as a raw material for carbon nanotubes may be introduced into the carbon source inlet part 110. In addition, a mixture comprising a carbon source and a catalyst may be introduced into the carbon source inlet part 110.

The manufacturing section 100 may further comprise a gas supply part 115. A carrier gas may be input into the carbon source inlet part 110 through the gas supply part 115. The mixture comprising the carbon source and the catalyst introduced into the carbon source inlet part 110 may be sprayed with the carrier gas input into the gas supply part 115. Accordingly, the carbon source and the catalyst may be dispersed in an aerosol state inside the reactor 120.

The carbon source is not particularly limited, but for example, a hydrocarbon may be used as the carbon source. For example, the hydrocarbon may comprise a chain-type saturated aliphatic hydrocarbon such as methane, ethane, propane, hexane, heptane, octane, nonane, decane, dodecane, and/or tetradecane, etc.; chain-type unsaturated aliphatic hydrocarbon having one or more double bonds, such as ethylene, acetylene, and/or propylene, etc.; cyclic saturated aliphatic hydrocarbon such as cyclohexane, etc.; and/or cyclic unsaturated hydrocarbon such as benzene, and/or toluene, etc. These may be used alone or in combination of two or more thereof.

In addition, the carbon source may comprise a hydrocarbon-based organic compound. For example, the carbon source may comprise alcohol such as ethanol or propanol.

The catalyst is not particularly limited, but may comprise, for example, a transition metal compound or transition metal microparticles as a metal-based catalyst. The transition metal compound may be decomposed within the reactor 120, thereby generating transition metal particles that can function as a direct catalyst.

The transition metal may comprise, for example, iron, nickel, cobalt, scandium, titanium, vanadium, chromium, and/or manganese, etc. The transition metal compound may comprise an organic or inorganic transition metal compound comprising the transition metal. The organic transition metal compound may comprise, for example, ferrocene, nickelosene, cobaltocene, iron carbonyl, iron acetylacetonate, and/or iron oleate, etc., and the inorganic transition metal compound may comprise, for example, iron chloride, etc. These may be used alone or in combination of two or more thereof.

The carrier gas may comprise, for example, argon, nitrogen, and/or hydrogen, etc. These may be used alone or in combination of two or more thereof.

The inside of the reactor 120 may comprise a catalyst aerosol. The catalyst particles may be dispersed in an aerosol state inside the reactor 120 by spraying the carrier gas, and the carbon source may be decomposed on the surface of the catalyst particles, thereby allowing the carbon nanotubes to grow.

The manufacturing section 100 may further comprise a heating means 140. The heating means 140 may be arranged outside of the reactor 120, and the heating means 140 may be used to apply a heat energy necessary for a reaction of carbon nanotube growth to the reactor 120.

When performing a reaction while heating the reactor 120 by the heating means 140, the carbon source may be decomposed at a high temperature, thereby allowing the carbon nanotubes to grow. The heating means 140 may increase the temperature in the reactor 120 to about 600° C. to 1500° C.

After the reaction is completed, a carbon nanotube aerosol may exist in the reactor 120. The carbon nanotube aerosol may be in a state where nano-sized carbon nanotube particles are dispersed in a gaseous medium (e.g., the carrier gas).

The reactor 120 may generate a carbon nanotube fluid in a first direction. The carbon nanotube fluid may comprise the carrier gas in which the carbon nanotubes are dispersed, and for example, the carbon nanotube fluid may comprise a single-walled carbon nanotube aerosol. As shown in FIG. 1, the reactor 120 may be a vertical type, and the first direction may be the direction of gravity. Alternatively, unlike the arrangement shown in FIG. 1, the reactor 120 may be a horizontal type, and the first direction may be a horizontal direction.

The carbon nanotube fluid may be discharged from the reactor 120 in the first direction through the outlet part 130. Accordingly, the carbon nanotubes in an aerosol state may be captured on a mesh belt to be described below, and an amount of the carbon nanotubes dispersed and lost to another space may be minimized.

Although not shown separately in the drawings, the outlet part 130 may comprise a flow rate control means for controlling the flow rate of the carbon nanotube fluid discharged therefrom, and may comprise, for example, a flow rate control means in the form of a propeller.

The carbon nanotube fluid may be generated only in a single direction of the first direction. Accordingly, it is possible to prevent the carbon nanotubes from being dispersed and lost.

Next, the carbon nanotube fluid may be supplied onto a conveyor unit (mesh belt) which travels continuously in a second direction perpendicular to the first direction to form carbon nanotube structures.

The capture section 200 may comprise a conveyor unit 210 and a collection unit 220. The conveyor unit 210 may comprise a mesh belt 212 and rollers 215, and the rollers 215 may drive the mesh belt 212. The mesh belt 212 may be arranged to be spaced apart from the outlet part 130 in the first direction, and may travel continuously in the second direction perpendicular to the first direction.

As shown in FIG. 1, when the reactor 120 is the vertical type, the first direction may be the direction of gravity, and the second direction may be the horizontal direction. Alternatively, unlike the arrangement shown in FIG. 1, when the reactor 120 is the horizontal type, the first direction may be the horizontal direction and the second direction may be the direction of gravity.

The carbon nanotube structures may be captured on the surface of the mesh belt 212. While a discharge stream A comprising the carbon nanotube fluid discharged from the outlet part 130, for example, the single-walled carbon nanotube aerosol, passes through the mesh belt 212, the carbon nanotube structures remain on the surface of the mesh belt 212, and an air stream A′ comprising the microparticle catalyst, etc., may be exhausted through the mesh belt. The carbon nanotube structure may comprise a plurality of individual carbon nanotubes, and each carbon nanotube may be aggregated due to van der Waals forces.

The mesh belt 212 may be driven by the rollers 215 without a separate support, and may comprise openings through which the carbon nanotube fluid can pass. Accordingly, the discharge stream A may be exhausted through a first portion adjacent to the reactor 120 of the mesh belt 212, and a second portion of the mesh belt 212 spaced apart from the first portion in the first direction. Since the discharge stream may be exhausted while continuously traveling, the carbon nanotubes comprised in the carbon nanotube structures captured on the surface of the mesh belt 212 may not be excessively aggregated.

The mesh belt 212 may have an appropriate line width and pitch to capture only the carbon nanotubes from the discharge stream. The mesh belt 212 may have a line width of about 1 μm to 3 μm, and a pitch of about 4 μm to 20 μm.

Within the above range, the carbon nanotubes may be captured with high efficiency while the air stream A′ may pass through the mesh belt without difficulty, and the carbon nanotubes may be continuously produced.

A ratio of a moving speed (cm/s) of the mesh belt 212 to a flow rate (cm³/s) at which the carbon nanotube fluid is discharged from the outlet part 130 may be 0.16 cm⁻² to 0.65 cm⁻². In some embodiments, the ratio of the moving speed (cm/s) of the mesh belt 212 to the flow rate (cm³/s) at which the carbon nanotube fluid is discharged from the outlet part 130 may be 0.23 cm⁻² to 0.42 cm⁻² or 0.3 cm⁻² to 0.35 cm⁻². Within the above range, the production speed may be increased while reducing the loss of carbon nanotubes, thereby improving the production efficiency of carbon nanotubes.

Next, carbon nanotube units may be collected from the carbon nanotube structures.

The carbon nanotube structures captured on the surface of the continuously traveling mesh belt 212 may be collected in the collection unit 220. The collection unit 220 may comprise a collection container 222 in which the carbon nanotubes are collected, and may comprise a brush unit 225 configured to collect the carbon nanotubes from the surface of the mesh belt 212.

The mesh belt 212 moves in the second direction, and the collection unit 220 may be arranged to be spaced apart from the mesh belt 212 in the second direction. Accordingly, the carbon nanotube structures on the surface of the mesh belt 212 may move in the second direction to be collected in the collection unit 220.

The carbon nanotube structures may be collected from the surface of the mesh belt 212 by the brush unit 225. The brush unit 225 may continuously rotate while in contact with the surface of the mesh belt 212, thereby collecting carbon nanotube structures with a predetermined size and gathering them into the collection container 222. For example, the carbon nanotube structures may be separated by the brush unit 225, such that the carbon nanotube units, which are individual carbon nanotube particles, may be collected into the collection container 222.

Although not shown separately in the drawings, the brush unit 225 may be disposed between the mesh belt 212 and the collection container 222, or may be fixed while in contact with the surface of the mesh belt 212 to scrape the carbon nanotubes such that the carbon nanotube units may be collected in the collection container 222. The brush unit 225 may rotate in a direction opposite to a moving direction of the mesh belt 212 at a portion where it comes into contact with the mesh belt 212. Accordingly, the brush unit 225 may scrape the carbon nanotubes from the surface of the mesh belt 212 as a scraper, and the carbon nanotube units may be collected in the collection container 222.

The conveyor unit 210 may comprise at least one roller 215 for driving the mesh belt 212. The number of rollers 215 may be increased or decreased in consideration of the length, density, and traveling speed of the mesh belt 212. As described above, the carbon nanotube units collected in the collection container 222 may be maintained in an optimal state for subsequent processing by minimizing agglomeration thereof.

The carbon nanotube unit may comprise single-walled carbon nanotubes (SWCNTs), multi-walled carbon nanotubes (MWCNTs), and/or thin-walled carbon nanotubes (TWCNTs), etc., and may comprise, for example, the SWCNTs.

The carbon nanotube production system may comprise the capture section 200 inside a housing 300 in which the mesh belt 212 is accommodated. When the carbon nanotube fluid is discharged from the outlet part 130, the housing 300 may separate an internal space from an outside so that the carbon nanotubes, which are microparticles, are not lost into the air.

The housing 300 may comprise a vent portion V through which the air stream A′ comprising the carbon nanotube fluid, for example, a residual catalyst, etc., which has passed through the mesh belt 212, is discharged. For example, the vent portion V may be positioned in a linear flow direction of the carbon nanotube fluid in the first direction. Accordingly, the carbon nanotube fluid may pass through the mesh belt in the shortest path to discharge the air stream A′, and an eddy current caused by the gas stream inside the housing 300 may be minimized. Accordingly, it is possible to prevent the very light individual carbon nanotubes from being lost or dispersed by the air current inside the housing 300.

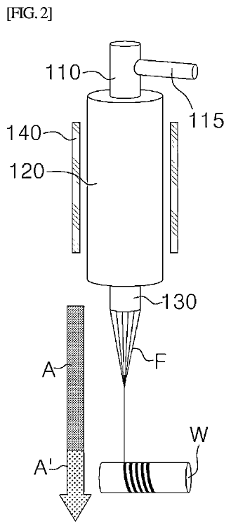

FIG. 2 is a schematic view illustrating a carbon nanotube production system according to a comparative example.

Referring to FIG. 2, the carbon nanotube production system according to the comparative example produces carbon nanotube fibers by aggregating and winding carbon nanotubes comprised in the discharge stream A discharged from the reactor 120 into a fiber form F. In this case, the carbon nanotubes aggregated in the direction of gravity are obtained by winding them onto the surface of the winding means W in the fiber form F, and the carbon nanotube fibers are excessively aggregated in a diameter direction and a length direction of the carbon nanotubes.

The carbon nanotube fibers produced from the carbon nanotube production system according to the comparative example need to be reprocessed or post-processed to obtain individual carbon nanotubes, which may be disadvantageous in terms of process and economy.

The carbon nanotube production system according to the present disclosure may capture carbon nanotube structures on the surface of the mesh belt in the carbon nanotube fluid state as they are in order to reduce the aggregation of the carbon nanotubes. Accordingly, the carbon nanotube units may be simply obtained without a separate post-process, thereby improving the efficiency of carbon nanotube production.

The carbon nanotube production system according to some embodiments may comprise one or more manufacturing sections 100. For example, the carbon nanotube production system may comprise one to ten manufacturing sections 100. Accordingly, it is possible to continuously produce the carbon nanotubes in large quantities.

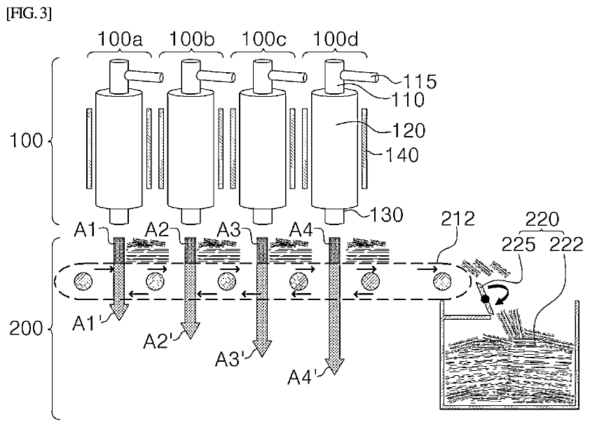

FIG. 3 is a schematic view illustrating a carbon nanotube production system according to some non-limiting embodiments or aspects of the present disclosure. Structures and configurations substantially the same as or similar to those described with reference to FIG. 1 will not be described in detail.

Referring to FIG. 3, the carbon nanotube production system may comprise a plurality of manufacturing sections 100a, 100b, 100c and 100d. FIG. 3 illustrates an example in which there are four manufacturing sections 100, but the number of manufacturing sections 100 may vary as described above. In FIG. 3, the housing 300 is not shown for the convenience of illustration.

Each of the manufacturing sections 100a, 100b, 100c and 100d may comprise a respective reactor.

In some embodiments, the plurality of manufacturing sections may comprise a first manufacturing section to an nth manufacturing section, where n may be an integer of 2 to 10. The first manufacturing section to the nth manufacturing section may be sequentially arranged to be spaced apart from each other in the second direction.

Continuously referring to FIG. 3, the plurality of manufacturing sections may be a first manufacturing section 100a, a second manufacturing section 100b, a third manufacturing section 100c and a fourth manufacturing section 100d arranged in this order in the second direction.

In some embodiments, a flow rate at which the carbon nanotube fluid of the m+1 manufacturing section is discharged may be greater than a flow rate at which the carbon nanotube fluid of the m manufacturing section is discharged. Herein, m is an integer of 1 to 9 and a number smaller than n.

In the plurality of manufacturing sections, a manufacturing unit positioned closer to the collection unit 220 may have a greater flow rate at which the carbon nanotube fluid is discharged. The greater the flow rate, the greater the amount of carbon nanotube structures captured on the surface of the mesh belt 212.

When the aerosol discharge flow rate of the first manufacturing section 100a, which discharges the carbon nanotubes on the mesh belt 212 first in the second direction, is the smallest, the amount of carbon nanotube structures captured on the surface of the mesh belt 212 may be relatively small, and thus, the mesh may be less clogged. Accordingly, the carbon nanotubes comprised in the discharge streams A2, A3 and A4 of the subsequent second to fourth manufacturing sections 100b, 100c and 100d may be captured with high efficiency, and the air streams A2′, A3′ and A4′ after the carbon nanotubes are captured may smoothly pass through the mesh belt 212.

In some embodiments, unlike as shown in FIG. 3, the flow rates at which the aerosols of the plurality of manufacturing sections are discharged may be the same as each other.

In general, carbon nanotubes manufactured by the FC-CVD method are obtained by being aggregated in the fiber form and wound outside the exhaust port. The carbon nanotube fibers are in a state where countless short carbon nanotubes are aggregated in the length direction and diameter direction. In order to use them in various fields, the carbon nanotube fibers should be subjected to a process of separating them into single-strand carbon nanotubes and/or short carbon nanotubes.

Since the carbon nanotube units produced from the carbon nanotube production system of the present disclosure are captured in a gaseous dispersion state, for example, in an aerosol state, immediately after being produced in the manufacturing section, carbon nanotube structures with minimized aggregation may be obtained.

Accordingly, short carbon nanotubes may be used without going through a separate process after being obtained, and the productivity of the carbon nanotubes may be increased.

The contents described above are merely an example of applying the principle of the present disclosure, and other configurations may be further included without departing from the scope of the present disclosure.

What is claimed is:

1. A system for producing carbon nanotubes comprising:
a reactor configured to generate a carbon nanotube fluid in a first direction;
a conveyor unit which is arranged spaced apart from the reactor in the first direction, and comprises a mesh belt configured to capture carbon nanotube structures from the carbon nanotube fluid while continuously traveling in a second direction perpendicular to the first direction; and
a collection unit configured to collect carbon nanotube units from the carbon nanotube structures.

2. The system for producing carbon nanotubes according to claim 1, wherein the carbon nanotube fluid comprises a single-walled carbon nanotube aerosol.

3. The system for producing carbon nanotubes according to claim 1, wherein the reactor comprises a floating catalyst chemical vapor deposition (FC-CVD) reactor.

4. The system for producing carbon nanotubes according to claim 1, further comprising a carbon source inlet part coupled to a front end of the reactor and an outlet part coupled to a rear end of the reactor to discharge the carbon nanotube fluid in the first direction.

5. The system for producing carbon nanotubes according to claim 4, wherein a ratio of a moving speed (cm/s) of the mesh belt to a flow rate (cm3/s) at which the carbon nanotube fluid is discharged from the outlet part is 0.16 cm−2 to 0.65 cm−2.

6. The system for producing carbon nanotubes according to claim 4, further comprising a gas supply part configured to supply a carrier gas to the carbon source inlet part.

7. The system for producing carbon nanotubes according to claim 1, wherein the conveyor unit further comprises rollers configured to drive the mesh belt.

8. The system for producing carbon nanotubes according to claim 1, wherein the collection unit comprises a brush unit configured to collect the carbon nanotube structures with a predetermined size.

9. The system for producing carbon nanotubes according to claim 1, wherein the mesh belt comprises openings through which the carbon nanotube fluid passes by penetrating the mesh belt.

10. The system for producing carbon nanotubes according to claim 9, further comprising a housing in which the mesh belt is accommodated, wherein the housing comprises a vent portion through which the carbon nanotube fluid passing through the mesh belt is discharged.

11. The system for producing carbon nanotubes according to claim 10, wherein the vent portion is positioned in a linear flow direction of the carbon nanotube fluid in the first direction.

12. The system for producing carbon nanotubes according to claim 1, wherein the system comprises a plurality of reactors spaced apart from each other in the second direction.

13. A method for producing carbon nanotubes, comprising:
generating a carbon nanotube fluid in a first direction;
supplying the carbon nanotube fluid onto a mesh belt continuously traveling in a second direction perpendicular to the first direction to form carbon nanotube structures; and
collecting carbon nanotube units from the carbon nanotube structures.

14. The method for producing carbon nanotubes according to claim 13, wherein the carbon nanotube fluid is generated only in a single direction of the first direction.

15. The method for producing carbon nanotubes according to claim 13, wherein the step of generating a carbon nanotube fluid comprises generating a single-walled carbon nanotube aerosol through a floating catalyst chemical vapor deposition (FC-CVD) process.
